(19) United States
(12) Patent Application Publication
(10) Pub. No.: US 2009/0224927 A1
(43) Pub. Date: Sep. 10, 2009

(54) Running Water Detection And Alert Device For Plumbing Fixtures

(76) Inventors: Jordan H. Sudy, (US); Abendigo P. Reebs, (US)

Correspondence Address: Jordan Harris Sudy, Apt. 21, 399 Steiner St., San Francisco, CA, 94117, US

(21) Appl. No.: 12/045,671

(22) Filed: Mar. 10, 2008

(51) Int. Cl. G08B 21/00

(52) U.S. Cl. 340/605

(57) ABSTRACT

In one embodiment a water leak detector and alarm unit senses sounds in the vicinity of a plumbing fixture, such as a toilet or sink. The characteristics of these sounds are used to determine the presence of a water leak and discriminate between a leak and normal water usage sounds. The unit comprises a microphone (105), electronic circuitry (110), a loudspeaker (115), an optional lamp (140), and an optional battery (120) or power supply (150). Signals from sound sensed by the microphone are amplified by an amplifier (400), and filtered by a filter (405) before being passed through a detector (410), an integrator (415), and a level discriminator (420). The discriminator quantifies and separates sounds into three categories: background, leak, and normal water usage levels. A particular signal is ascribed to each category. These signals are fed to a logic unit (425) for analysis and possible activation of an alarm (115). A series of timers (430, 435, 440) are used to control the duration of sensing and alarm activities of the unit. Alarm duration is optionally limited and false alarms are minimized.

### BACKGROUND

1. Field The field is leak detection, in particular detecting and providing an alarm for water running in plumbing fixtures.

2. Prior-Art Diffusers and Reflectors

The following is a list of some prior art that presently appears relevant:

| | | | Patentee or |
|---|---|---|---|
| Patent or Pub. Nr. | Kind Code | Issue or Pub. Date | Applicant |
| 5655561 | B1 | 1997-08-12 | Wendel et al. |
| 6671893 | B1 | 2004-01-06 | Quintana et al. |
| 6715165 | B1 | 2004-04-06 | Schommer |
| 6877170 | B1 | 2005-04-12 | Quintana et al. |
| 6934977 | B1 | 2005-08-30 | Quintana et al. |
| 2005/0248465 | A1 | 2005-11-10 | Flaherty |
| 2005/0275546 | A1 | 2005-12-15 | McKenna et al. |

Detection and alarm systems for water leaks are well known. For example, Wendel et al. show a wireless system for detecting and stopping water leaks. A closely-spaced pair of electrically energized electrodes is placed within an area that is likely to accumulate water in the event of a leak. When sufficient current passes between the electrodes and through a detecting circuit, an audible alarm sounds and a radio-frequency transmitting circuit is energized and transmits an alarm signal to a remote receiver circuit. In addition to alarms, provision is made to activate a solenoid valve to stop the flow of water. The complexity of this system will be reflected in its price, which must include proper training for installation and service. A system this complex is non-disposable.

Quintana et al. '893 show a system for preventing overflow of a toilet or urinal. A normally-open solenoid valve is inserted between the water supply and the plumbing fixture. One or more water sensors are located near the inside, top edge of the fixture. The sensors are connected to a circuit that controls operation of the solenoid valve. When a drain blockage occurs, water contacts the sensor, sending a signal to the circuit. In turn, the circuit causes the solenoid valve to close, thereby preventing overflow. Audible and visual alarms can be activated when the valve is closed. While this system prevents overflows, it does not solve the problem of a leaky water valve passing water into a toilet or urinal that is not blocked since the sensors will never be contacted by water.

Quintana et al. '170 show an elaborate toilet water measuring and flow control system that includes leak and overflow detection and prevention. This system contains many elements. It would not be disposable in the event of failure and it would require a highly-skilled technician for installation and repair.

Quintana et al. '977 show a complex, microprocessor-based toilet leak detection and overflow prevention system. As in the case of the above two systems, the complexity of the system causes it to require expert installation and maintenance. It would not be disposable in the event of failure, and it would be expensive.

Schommer shows a simple leak detection technique for toilets. A disclosure liquid having high color density is applied around the inner circumference of a toilet bowl, above the resting water line and below the rim drain holes. If a toilet is leaking, water will pass through the drain holes and locally wash away the colored liquid, leaving white streaks. While this system is effective at exposing leaky toilets, it requires application and subsequent evaluation by a user. The disclosure liquid will be removed from the toilet bowl as soon as the toilet is flushed. This limits the long-term utility of this technique.

Flaherty shows a leak alarm for toilets and faucets that includes a liquid flow detector and an electronic alarm circuit having two resettable and cooperating timers. A liquid flow detector is inserted in the water supply line for the toilet. Simple logic is employed to observe the operation of the timers and an alarm is sounded when this logic operation detects a leak. As with the previous prior-art designs, this alarm requires installation of a flow detector in the water supply line for the plumbing fixture.

A commercial leak detector, model LD-12, manufactured by SubSurface Leak Detection, Inc., of San Jose, Calif., USA, is used industrially to detect leaks in water pipes. A microphone is used to detect sound emanating from a leak. The sound is amplified and filtered to provide a passband of frequencies between 100 and 1,200 Hz. The filtered sound is delivered to earphones worn by an operator. The filter removes or diminishes extraneous sounds from the environment. The optimum filter passband is determined by the type of leak. This instrument is designed for use by skilled personnel. It does not include a timing function to determine the duration of a leak.

All of the above prior-art detectors and alarms have one or more of the following disadvantages. All are complex and elaborate and require installation of components either in the vessel, such as the toilet, urinal or toilet tank, or the supply pipe leading to the fixture. Many fixtures, such as sinks and bathtubs, include an overflow drain. If water leaks into the fixture and flows out through the overflow drain, water will be wasted yet no alarm will sound. None is sufficiently simple and inexpensive to be disposable and all require either plumbing or electrical skills, or both, in order to install and maintain them.

### SUMMARY

In accordance with an aspect of one embodiment, an alarm unit comprises a microphone, amplifier, timer, logic circuitry, and audible alarm. The unit is capable of receiving and amplifying sounds of running water in a fixture such as a toilet or sink, and announcing an alarm condition when water is permitted to run for longer than a predetermined time period. In another aspect, the alarm unit further includes a radio transmitter that can relay an alarm condition to a remote receiver, whereupon the receiver can activate an alarm. In another aspect the alarm unit is battery powered or powered by mains. In still another aspect, the unit does not require installation by an expert. In another aspect, the alarm unit is sufficiently simple as to be inexpensive and disposable.

### DRAWING FIGURES

FIGS. 1 through 3 are plan, side elevation, and end elevation views, respectively, of a first embodiment.

FIG. 4 is a block diagram of an electronic circuit shown in FIGS. 1-3.

FIG. 5 shows placement of an embodiment inside or outside a toilet tank.

FIG. 6 shows placement of an embodiment outside a sink or urinal.

FIG. 7 is a flow chart showing the logical operation of the circuit in FIG. 4.

### DRAWING FIGURE REFERENCE NUMERALS

100 Board
105 Microphone
110 Circuit
115 Alarm
120 Battery
125 Housing
130 Hole
135 Grill
140 Lamp
145 Alarm
150 Power supply
155 Cord
200 Strip
400 Amplifier
405 Filter
410 Detector
415 Integrator
420 Discriminator
425 Logic
430 Timer
435 Timer
440 Timer
500 Wall
505 Connection
600 Sink or urinal
605 Water supply line
700-755 Blocks

### FIRST EMBODIMENT

### Description

### FIGS. 1 Through 4

FIG. 1 shows a top view of one aspect of a first embodiment of a water leak detection and alarm unit. Such a unit detects water leaks that might go unnoticed, either because of absence of persons from a structure, or because the leak occurs in a fixture that has a water-overflow drain, such as a sink or toilet. In the first case, flooding of the structure can occur. In the second case, wastage of water occurs because after it is delivered from the water supply line, it passes through the fixture and into the sewer without serving a useful purpose.

An electronic circuit board 100 contains a microphone 105, a battery 120, an alarm 115, and detection circuitry 110, comprising an amplifier 400, filter 405, signal detector 410, optional integrator 415, and discriminator 420. Board 100 also contains logic circuitry 425 connected to detection circuitry 110 and incorporating timers 430, 435, and 440. Board 100 and associated components are housed in a case or housing 125. A hole 130 enables sound from outside housing 125 to reach microphone 105. Similarly, a grill 135 permits sound from alarm 115 to radiate outside case 125. An optional lamp, such as a light-emitting diode (LED) 140, is arranged to shine outside case 125 to provide a visible alarm.

The openings (hole 130 and grill 135) can optionally be covered by a thin, sonolucent membrane to prevent water from entering housing 125.

An optional external alarm 145 can be provided to furnish a remote indication of a leak, if desired. An optional power supply 150 is connected to circuit board 100 by a cord 155 to deliver power to circuitry 110, in lieu of power supplied by battery 120. Alternatively, supply 150 can provide current to charge battery 120.

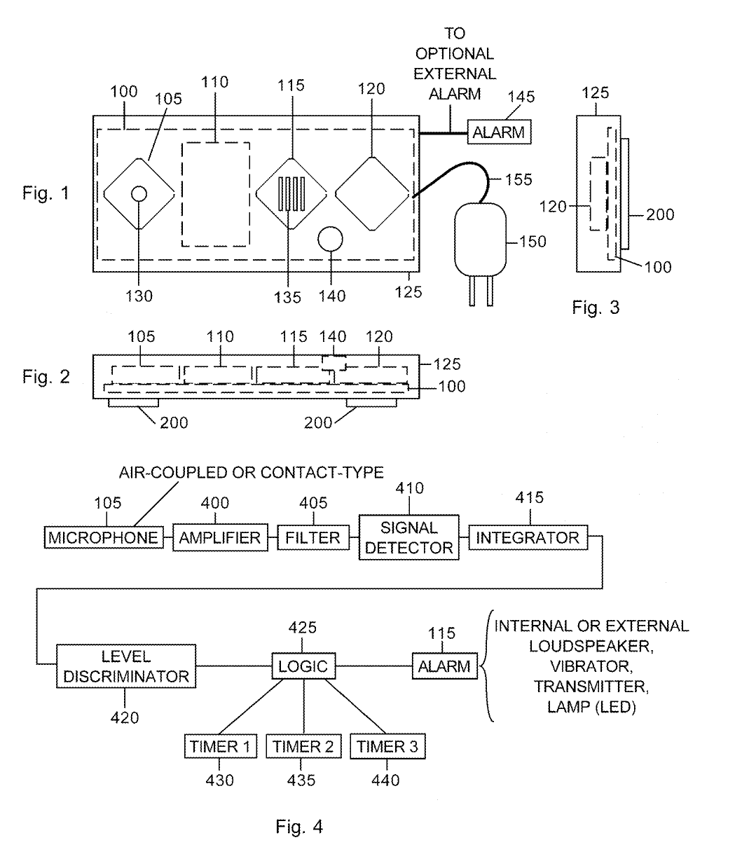

FIGS. 2 and 3 show side and end elevations of the detection and alarm unit. One or more two-sided, adhesive strips 200 are affixed to the outside of case 125. These facilitate mounting the detection and alarm unit. Alternatively, the unit can be attached to a surface by screws or rivets, adhesive goo, or left unattached.

Microphone 105 may be a standard, air-coupled model DOM-5242L-R, manufactured by Projects Unlimited, of Dayton, Ohio, USA. Alternatively, a contact-type microphone, such as the model CM-1 sold by Sabine, Inc., of Alachua, Fla., USA, or equivalent can be used. Audible alarm 115 may be provided by part number PB-1220PQ, manufactured by Mallory Sonalert Products Inc., of Indianapolis, Ind., USA. Other suitable alarm types include internal or external loudspeakers, vibrators, transmitters, and lamps.

Battery 120 is preferably a lithium cell since they have long life. If power supply 150 is used to charge battery 120, then a rechargeable lithium cell is used. The remaining components are well-known and widely available from a variety of manufacturers.

Housing 125 is preferably approximately 10 cm long, 5 cm wide, and 1.5 cm thick overall, although other sizes can be used. Housing 125 is preferably made of polycarbonate, polyamide, or another sturdy plastic material, although wood or metal can be used. Although housing 125 is shown with a rectangular shape, a decorative shape can be used without altering performance of the detector-alarm unit.

FIG. 4 shows a block diagram of circuitry 110. Circuitry 110 senses and discriminates among various water flow sounds, including background (no water sound), leak sounds, and normal water usage sounds (toilet flush, sink usage, etc.). Microphone 105 converts ambient sound to an electrical signal. This signal is amplified by an amplifier 400 and delivered to a filter 405. Filter 405 is preferably a bandpass filter, although it could also be a high-pass or low-pass filter, depending on the audio characteristics of microphone 105. Filter 405 preferably has a band pass between 100 and 1500 Hz, although other frequencies and wider or narrower passbands can be used. These concepts are well-understood by those skilled in the art of electrical engineering.

Filter 405 is followed by a signal detector 410 that converts the amplitude of the signal from filter 405 to a representative voltage level. An integrator 415 follows detector 410. Integrator 415 time-averages signals at its input, effectively smoothing the output of detector 410, thereby preventing large transient signals at its output. If allowed to pass through the circuitry in FIG. 4, such transients could cause false alarms. In lieu of an integrator, programming in logic circuit 425 (described below) can time-average each signal type provided by discriminator 420 (also described below). In the event integrator 415 is not used, the output signal of detector 410 is connected directly to the input of discriminator 420.

The output of integrator 415 (if present) is delivered to a level discriminator 420. Discriminator 420 delivers signals representative of the rate of water flow: no flow, leak flow rate, normal usage flow rate. Signals in the absence of flow include normal background activity, such as voices, traffic, and the like. Many of these signals are removed or reduced by filter 405 and their effect on leak detection is reduced by integrator 415. Signals indicative of a leak have a low amplitude and are steady. Signals indicative of normal usage flow have a high amplitude, such as occur during the flushing of a toilet and running water in the sink.

The output of discriminator 420 is fed to logic circuit 425 and three timers 430, 435, and 440. Timers 430, 435, and 440 are interval timers. They are activated and reset by logic circuit 425. Logic circuit 425 also queries timers 430, 435, and 440 to detect whether their preset timing duration has been reached.

Timer 430 is a leak timer. It is activated by logic 425 when discriminator 420 detects signals indicative of a leak. It is preset with a duration of T1=20 minutes. When logic 425 queries timer 430 and detects that its preset duration has been reached, logic 425 activates alarm 115. Thus timer 430 permits alarms to occur only for leakage flows lasting longer than 20 minutes, thereby preventing false alarms.

Second timer 435 is an alarm-duration timer. It is activated by logic 425 when logic 425 activates alarm 115. Timer 435 establishes the duration of the alarm cycle, typically T₂=10 minutes, in the event of a continuous leak. Logic 425 continuously queries timer 435 and when the preset duration T₂ is reached, logic 425 resets itself, timers 430, 435, and 440, and alarm 115. This limits the duration of the alarm cycle prevents annoying noises and also lengthens the life of battery 120.

Third timer 440 is an interval timer and establishes a listening period T3, typically one minute, during which alarm 115 is silenced and microphone 105 listens for normal usage sounds. Timer 440 is activated by logic 425 when timer 435 is activated. When timer 440 is active, alarm 115 continues to sound. When logic 425 detects that timer 440 has reached its preset period, T3, logic 425 silences alarm 115 and permits microphone 105 to listen for normal usage flow sounds. If none are heard, logic 425 re-activates alarm 115 and resets timer 440. Thus alarm 115 sounds for a period T₃, is silenced while microphone 105 listens for normal usage flow sounds, then alarm 115 sounds again, resulting in intermittent alarm sounds lasting for durations of period T₃.

The preset durations of timers 430, 435, and 440 can take other values, depending upon the nature of a particular alarm installation. Although use of a single alarm sound is described here, alternative sounds can be selected by logic 425 to indicate the duration of a leak. A first alarm can be indicated by a relatively low-volume alarm sound. Subsequent alarms can be indicated by progressively louder, more strident, or different sounds.

An alarm 115 is also connected to logic circuit 425. Alarm 115 can include a loudspeaker, vibrator, transmitter, and a lamp such as an LED. Any of these alarm modalities can be located within the detector-alarm unit, or externally. If a transmitter is used, additional alarming function is supplied by a receiver (not shown) that is activated when the transmitter sends an alarm signal.

Amplifier 400 can have adjustable gain and filter 405 can have adjustable bandpass characteristics. These adjustments permit fine-tuning the detector-alarm unit for a particular application. Logic 425 and timers 430, 435, and 440 can be embodied in a microprocessor. The functions of filter 405, detector 410, integrator 415, and discriminator 420 can be provided by digital or analog electronics, or a combination, as is well-known by those skilled in the art of electrical engineering.

### FIRST EMBODIMENT

### Operation

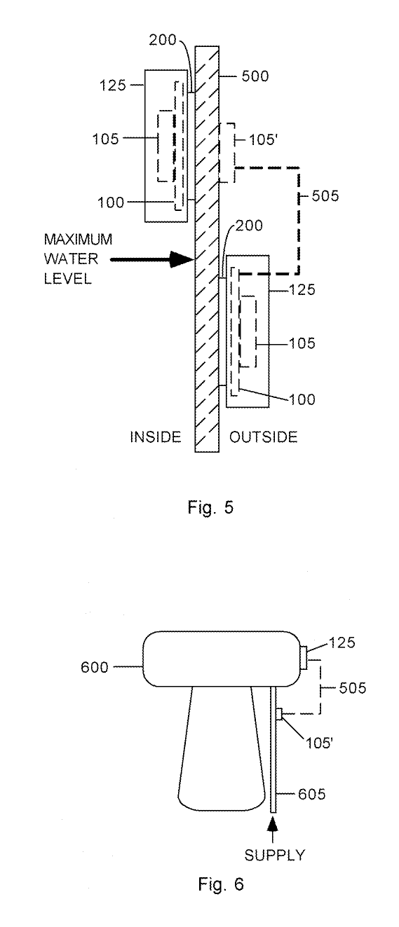

### FIGS. 5 Through 7

FIG. 5 shows one possible placement of the detector alarm unit: inside or outside a toilet tank wall 500.

For the inside case, housing 125 is secured to the left or inside of wall 500 by waterproof adhesive 200. Microphone 105 detects water flow sounds from within the tank. Housing 125 is placed at a point above the maximum water level in order to keep circuit board 100 and all related components dry.

Alternatively, the detector alarm unit can be placed on the right or outside the toilet tank wall. In this case housing 125 is again secured to wall 500 by adhesive 200.

In another alternative aspect, microphone 105 is supplemented or replaced by a contact-type microphone 105′. Microphone 105′ is connected to circuit board 100 by a wire connection 505. Microphones 105 and 105′ can be connected in series or parallel if sounds from both are to be used. Alternatively, only one microphone is used.

FIG. 6 shows another possible placement of housing 125 of the detector alarm unit: secured to a sink or urinal 600. A water supply line 605 supplies water to sink 600. As in FIG. 5, microphone 105 (not shown in this figure) can be used alone or in combination with an external contact-type microphone 105′. In this example, microphone 105′ is affixed to supply line 605.

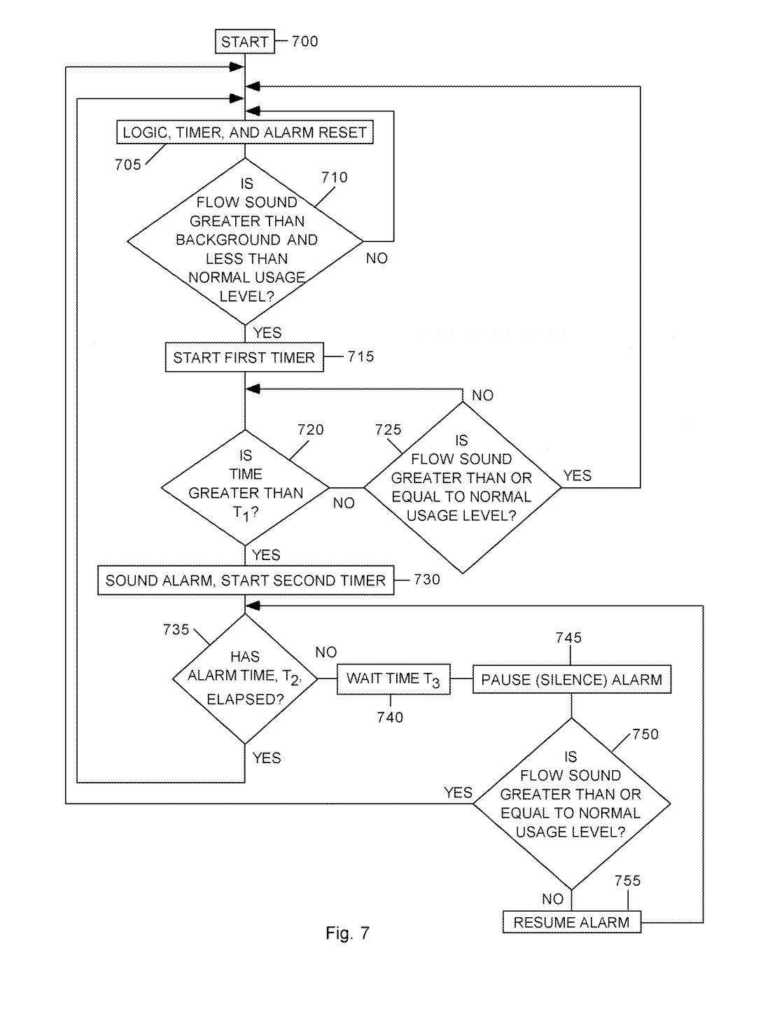

FIG. 7 is a flow chart showing operation of the detector-alarm unit. The unit is placed inside, behind, or on a plumbing fixture such as a toilet tank, urinal, or sink as shown in FIGS. 5 and 6, or any other plumbing fixture, such as a tub, shower, etc., which the user desires to monitor for a leak.

Operation of the unit begins when it is energized by insertion of battery 120 or connection to power supply 150 (FIG. 1). Logic 425 controls the following sequence of events. Upon power-up (block 700), logic 110 resets logic circuit 425, timers 430, 435, and 440, and alarm 115 (block 705). Alarm 115 is silent when it is in its reset condition. Next, logic 425 monitors the output of discriminator 420 for signal amplitudes that indicate a leak, i.e., amplitudes greater than background noise and less than normal usage level, such as flushing (block 710). If a leak is not detected, the system is reset (block 705) and the detector-alarm system continues listening.

If a leak is detected, i.e., flow sound is greater than background noise and less than normal usage level, logic 425 starts a first timer 430 (block 715). Timer 430 is preset with a time-out of T₁, normally about 20 minutes, although another predetermined time can be selected. This delay prevents false alarms that may occur, such as when flow slows during normal filling of a toilet tank, for example.

Next, logic 425 tests to see if time T₁ (20 min. in this example) has been exceeded (block 720). If T₁ has not been exceeded, the system listens for activity such as a flush (block 725). If there is no flush, i.e., flow sounds remain at the leak level, leak monitoring continues (block 720). If the flow sound is greater than or equal to normal water usage level, i.e., a toilet is flushed, the system is reset and leak monitoring is re-initiated.

If time T₁ is exceeded during a leak, an alarm condition is sounded and logic 425 starts a second timer 435 (block 730). The alarm condition will continue until the second timer's preset time (10 min. in this example) time T₂ has elapsed (block 735).

If T₂ has not elapsed, logic 425 starts a third timer 440 that introduces a wait time T₃, normally on the order of one minute (block 740), although other times can be used.

After time T₃ has elapsed, logic 425 silences loudspeaker 115 (FIG. 1) (block 745) and the system listens to determine if the flow sound is greater than or equal to normal usage level, i.e., a flush has occurred (block 750). This is done to prevent continuation of the alarm condition when the condition is no longer detectable. If normal usage levels are not detected (block 750), the alarm condition is resumed (block 755) and the system waits for the lapse of time T₂. The loop including blocks 740, 745, 750, and 755 continues until normal usage is detected (block 750) or time T₂ has elapsed (block 735), and results in an alarm sequence of alarm-pause-alarm-pause until the loop is exited. If flow sound is greater than or equal to normal usage level (block 750), or time T₂ has elapsed (block 735), the sequence of events returns to block 705 and the system is reset to its initial power-up condition.

The above-described sequence of events continues as long as the detector-alarm unit is energized.

### CONCLUSION, RAMIFICATIONS, AND SCOPE

The embodiments shown of our water leak detector-alarm unit provide several useful and advantageous features. A water leak is detected audibly by an inexpensive, rugged, disposable, unobtrusive unit. The unit can be placed by an unskilled user and can be hidden behind or within a toilet tank, or behind a sink. No external wiring is required, although it can be provided to extend battery life or eliminate the need for a battery, if desired. When a water leak is detected, the unit sounds an audible or visible alarm, or both. The alarm condition can be transmitted to a remote location by a wire connection or by radio-frequency signaling.

While the above description contains many specificities, these should not be considered limiting but merely exemplary. Many variations and ramifications are possible. For example, the unit can be used to detect and alarm for leaks in plumbing other than toilets and sinks, such as swimming pools, aquariums, underground pipes, water purifiers, desalination units, refrigerators with ice makers, dishwashers, and the like. Instead of an intermittent sound, the alarm can be a steady sound whose frequency lies outside the bandpass of the filter used in the detector. Instead of a combination of digital and analog circuitry, all-analog or all-digital circuitry can be used. Alarm sounds can include wailing, beeping, clicking, chirping, and buzzing. Instead of double-stick tape, glue, nails, screws, rivets, and clamps can be used to secure the unit on or near a plumbing fixture. An alarm sound, different from the leak indication sound, can also be used to indicate a low-battery condition. Instead of being reset after the duration of the second timer has elapsed, the alarm can be made to sound or flash lights continuously, dial a predetermined phone number, flash lights or activate sounds at a remote location in case the area is not monitored or occupied.

While the present system employs elements which are known to those skilled in the art of water leak detector and alarm design, it combines these elements in a novel way which produces new results not heretofore discovered. Accordingly the scope should be determined, not by the embodiments illustrated, but by the appended claims and their legal equivalents.

1. A detection and alert device for water leaks, comprising:
a microphone,
detection circuitry connected to said microphone and arranged to provide a plurality of logic signals representative of receipt of background, water leak, and normal water usage sounds by said microphone,
logic circuitry responsive to said logic signals arranged to reset itself and to activate and reset an alarm,
a plurality of timers, a first of said timers being arranged to establish a first listening period to determine the presence of said water leaks, a second of said timers being arranged to determine the duration of activation of said alarm, and a third of said timers being arranged to cause said logic to silence said alarm for a second listening period to determine the presence of normal water usage sounds,
said logic circuitry being arranged to query and respond to said plurality of timers so that when said detection circuitry detects said water leak sound lasting for longer than a predetermined period and uninterrupted by said normal water usage sound, said logic circuitry will respond and activate said alarm for a predetermined period unless said normal usage sound is detected or until said second predetermined period is exceeded, whereupon said logic circuitry will silence said alarm and reset said timers.

2. The device of claim 1, further including means for energizing said circuitry, said means selected from the group consisting of batteries, power supplies, and combinations thereof.

3. The device of claim 1 wherein said alarm is selected from the group consisting of internal or external loudspeakers, vibrators, transmitters, and lamps.

4. The device of claim 1 wherein said circuitry comprises a microphone, an amplifier, a filter, a signal detector, a level discriminator, and a logic circuit.

5. The device of claim 4, further including an integrator connected to said signal detector to provide a time average of signals at the output of said detector.

6. The device of claim 1, further including a housing with a plurality of openings and containing said microphone, said circuitry, said timers, and said alarm.

7. The device of claim 6 wherein a sonolucent membrane covers said openings.

8. The device of claim 1 wherein said circuitry is selected from the group consisting of analog, digital, and a combination thereof.

9. A method for detecting water leaks, comprising:
providing a microphone,
providing circuitry connected to said microphone and arranged to provide a plurality of logic signals representative of the receipt of background, water leak, and normal water usage sounds by said microphone, said circuitry further including first, second, and third timers, respectively arranged to sense first, second, and third predetermined timing periods,
providing an alarm,
energizing said circuitry,
activating said first timer when said water leak sound is present,
deactivating said alarm and resetting said circuitry and said timers when said normal usage sound is sensed prior to the end of said first timing period,
activating said alarm and said second timer when said water leak sound is present and said first timer exceeds said first timing period,
silencing said alarm after said third timing period in order for said circuitry to sense said normal usage sound,
deactivating said alarm and resetting said circuitry and said timers when said normal usage sound is sensed,
resuming activation of said alarm for the remainder of said second timing period, and
deactivating said alarm and resetting said circuitry and said timers after said second timing period.

10. The method of claim 9, further including means for energizing said circuitry, said means selected from the group consisting of batteries, power supplies, and combinations thereof.

11. The method of claim 9 wherein said alarm is selected from the group consisting of internal or external loudspeakers, vibrators, transmitters, and lamps.

12. The method of claim 9 wherein said circuitry comprises a microphone, an amplifier, a filter, a signal detector, a level discriminator, and a logic circuit.

13. The method of claim 12, further including an integrator connected to said signal detector to provide a time average of signals at the output of said detector.

14. The method of claim 9, further including a housing with a plurality of openings and containing said microphone, said circuitry, said timers, and said alarm.

15. The method of claim 14 wherein a sonolucent membrane covers said openings.

16. The method of claim 9 wherein said circuitry is selected from the group consisting of analog, digital, and a combination thereof.

17. The method of claim 9 wherein said circuitry further includes a filter arranged to pass sounds within the spectrum of frequencies bounded by 100 and 1500 Hz.

18. The method of claim 9 wherein said microphone is selected from the group consisting of air-coupled and contact types.

19. A system for detecting water leaks and sounding an alarm, comprising:
a microphone,
circuitry connected to said microphone and arranged to provide a plurality of logic signals representative of receipt of background, water leak, and normal water usage sounds by said microphone,
timer means arranged to determine the duration of said sounds,
energizing means for energizing said microphone, said circuitry, and said timer means, and
alarm means,
said circuitry being arranged so that when said device is energized and said circuitry detects said water leak sound lasting for longer than a predetermined period and uninterrupted by said normal water usage sound, said circuitry will activated said alarm for a predetermined period unless said normal usage sound is detected or until said predetermined period is exceeded, whereupon said circuitry will silence said alarm and said circuitry and said timers are reset.

20. The system of claim 19, wherein said circuit means and said timer means comprises microprocessor.
